(19) United States
(12) Patent Application Publication
(10) Pub. No.: US 2015/0058796 A1
(43) Pub. Date: Feb. 26, 2015

(54) NAVIGATION CONTROL FOR A TABLETOP COMPUTER SYSTEM

(71) Applicant: General Electric Company, Schenectady, NY (US)

(72) Inventors: Pavan Kumar Singh Thakur, Hyderabad (IN); Justin Varkey John, Cohoes, NY (US); Venkatesh Mani Selvaraj, Hyderabad (IN)

(73) Assignee: General Electric Company, Schenectady, NY (US)

(21) Appl. No.: 13/974,109

(22) Filed: Aug. 23, 2013

(51) Int. Cl. G06F 3/0488; G06F 3/0481

(52) U.S. Cl. CPC G06F 3/0488; G06F 3/04817
USPC 715/800; 715/781

(57) ABSTRACT

One aspect of the invention is a system for providing navigation control for a tabletop computer system. The system includes a multi-touch display and processing circuitry coupled to the multi-touch display. The processing circuitry is configured to display a user interface on the multi-touch display and render a navigation pane on the multi-touch display. The navigation pane includes a reduced-scale copy of the user interface. The processing circuitry is also configured to detect a touch-based input at a position on the navigation pane and determine a scaled position on the user interface corresponding to the position on the navigation pane. The processing circuitry is further configured to interpret the touch-based input at the position on the navigation pane as an equivalent touch-based input at the scaled position on the user interface and trigger an event corresponding to the equivalent touch-based input at the scaled position on the user interface.

### BACKGROUND OF THE INVENTION

The subject matter disclosed herein relates to computer system user interfaces, and more particularly, to navigation control for a tabletop computer system.

A tabletop computer system is typically oriented to provide a substantially flat table-like work surface, i.e., parallel to floor with an upward facing display. A tabletop computer system also typically has a relatively large surface area display that is touch sensitive. The display provides a touch-sensitive user interface, where touch-based user interaction can occur at any location on the display. With larger display areas it can be cumbersome for a user to navigate the touch-sensitive user interface. Reaching across the display to touch a distant location is one challenge, while make long dragging motions on the touch-sensitive user interface is another challenge. The challenges can be greater for users having a shorter arm length or reduced physical mobility.

### BRIEF DESCRIPTION OF THE INVENTION

One aspect of the invention is a system for providing navigation control for a tabletop computer system. The system includes a multi-touch display and processing circuitry coupled to the multi-touch display. The processing circuitry is configured to display a user interface on the multi-touch display and render a navigation pane on the multi-touch display. The navigation pane includes a reduced-scale copy of the user interface. The processing circuitry is also configured to detect a touch-based input at a position on the navigation pane and determine a scaled position on the user interface corresponding to the position on the navigation pane. The processing circuitry is further configured to interpret the touch-based input at the position on the navigation pane as an equivalent touch-based input at the scaled position on the user interface and trigger an event corresponding to the equivalent touch-based input at the scaled position on the user interface.

Another aspect of the invention is a method for providing navigation control for a tabletop computer system. The method includes displaying a user interface on a multi-touch display and rendering, by processing circuitry coupled to the multi-touch display, a navigation pane on the multi-touch display. The navigation pane includes a reduced-scale copy of the user interface. The method also includes detecting, by the processing circuitry, a touch-based input at a position on the navigation pane and determining, by the processing circuitry, a scaled position on the user interface corresponding to the position on the navigation pane. The processing circuitry interprets the touch-based input at the position on the navigation pane as an equivalent touch-based input at the scaled position on the user interface. The processing circuitry triggers an event corresponding to the equivalent touch-based input at the scaled position on the user interface.

Another aspect of the invention is a computer program product for providing navigation control for a tabletop computer system. The computer program product includes a non-transitory computer readable medium storing instructions for causing processing circuitry coupled to a multi-touch display to implement a method. The method includes displaying a user interface on the multi-touch display and rendering a navigation pane on the multi-touch display. The navigation pane includes a reduced-scale copy of the user interface. The method also includes detecting a touch-based input at a position on the navigation pane and determining a scaled position on the user interface corresponding to the position on the navigation pane. The processing circuitry interprets the touch-based input at the position on the navigation pane as an equivalent touch-based input at the scaled position on the user interface. The processing circuitry triggers an event corresponding to the equivalent touch-based input at the scaled position on the user interface.

These and other advantages and features will become more apparent from the following description taken in conjunction with the drawings.

### BRIEF DESCRIPTION OF THE DRAWING

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 depicts a perspective view of a tabletop computer system;

FIG. 2 depicts a block diagram of the tabletop computer system of FIG. 1;

FIG. 3 depicts an example of a user interface;

FIG. 4 depicts an example of a navigation pane for the user interface of FIG. 3;

FIG. 5 depicts an example of a navigation pane including a control bar for the user interface of FIG. 3;

FIG. 6 depicts an example of moving the navigation pane of FIG. 5;

FIG. 7 depicts another embodiment of a navigation pane;

FIG. 8 depicts an example of multiple navigation panes with control bars; and

FIG. 9 depicts a process for providing navigation control for a tabletop computer system in accordance with exemplary embodiments.

The detailed description explains embodiments of the invention, together with advantages and features, by way of example with reference to the drawings.

### DETAILED DESCRIPTION OF THE INVENTION

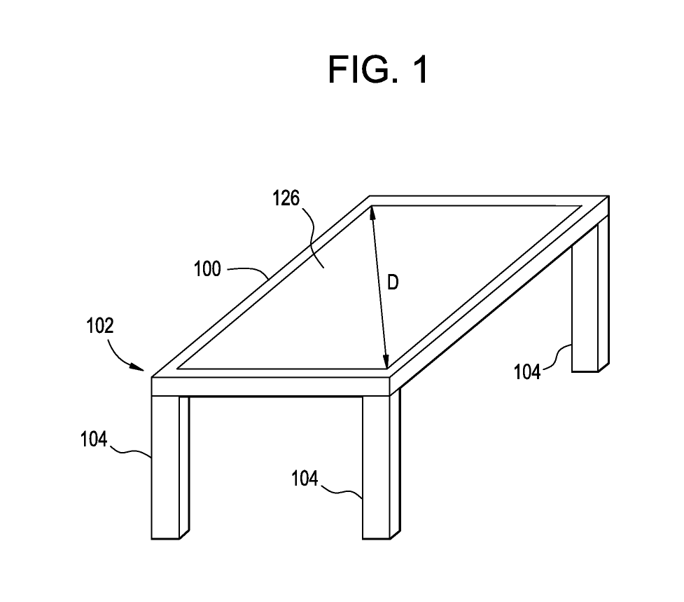

FIG. 1 illustrates a perspective view of a tabletop computer system 100 that includes a structure 102 configured to place a multi-touch display 126 in a substantially flat table-like orientation. The structure 102 may include multiple legs 104 to support the multi-touch display 126 in a substantially fixed position. The multi-touch display 126 can display text and images, as well as recognize the presence of one or more points of contact as input. The multi-touch display 126 of FIG. 1 has a diagonal measurement D that is relatively large. In one example, the diagonal measurement D is between 42 inches (106.68 cm) and 60 inches (152.4 cm). In another example, the diagonal measurement D is greater than 60 inches (152.4 cm). Accordingly, the multi-touch display 126 is characterized as having a relatively large display area as compared to a smaller desktop, laptop, or handheld touch-sensitive computer system.

Exemplary embodiments provide navigation control for the tabletop computer system 100. Applying touch-based inputs directly at any position on the multi-touch display 126 of the tabletop computer system 100 may become challenging for larger values of the diagonal measurement D. Exemplary embodiments, as further described herein, provide a navigation pane on the multi-touch display 126 that displays a reduced-scale copy of a user interface of the multi-touch display 126. The tabletop computer system 100 includes processing circuitry that is configured to detect touch-based input at a position on the navigation pane and determine a scaled position on the user interface corresponding to the position on the navigation pane. The touch-based input at the position on the navigation pane is interpreted as an equivalent touch-based input at the scaled position on the user interface, resulting in triggering of an event corresponding to the equivalent touch-based input at the scaled position on the user interface. Although the system described herein refers to a tabletop computer system, the system and methods described herein can apply to touch-sensitive computer systems in a variety of orientations, such as a wall-mounted computer system.

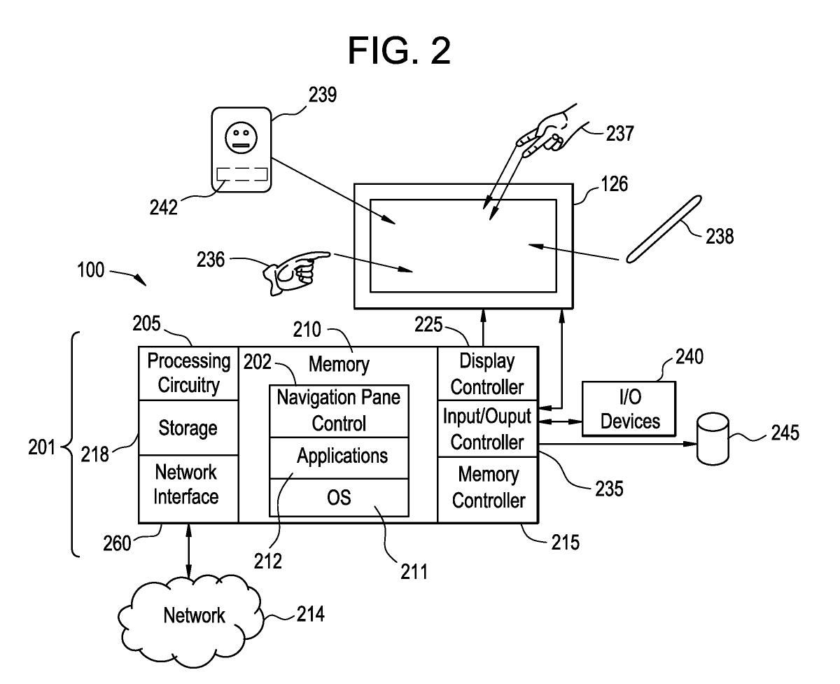

FIG. 2 illustrates an exemplary embodiment of the tabletop computer system 100 of FIG. 1 that can be implemented as a touch-sensitive computing device as described herein. The methods described herein can be implemented in software (e.g., firmware), hardware, or a combination thereof. In exemplary embodiments, the methods described herein are implemented in software, as one or more executable programs, and executed by a special or general-purpose digital computer, such as a personal computer, mobile device, workstation, minicomputer, or mainframe computer operably coupled to or integrated with a multi-touch display. The tabletop computer system 100 therefore includes a processing system 201 interfaced to the multi-touch display 126 as described in FIG. 1.

In exemplary embodiments, in terms of hardware architecture, as shown in FIG. 2, the processing system 201 includes processing circuitry 205, memory 210 coupled to a memory controller 215, and one or more input and/or output (I/O) devices 240, 245 (or peripherals) that are communicatively coupled via a local input/output controller 235. The input/output controller 235 can be, but is not limited to, one or more buses or other wired or wireless connections, as is known in the art. The input/output controller 235 may have additional elements, which are omitted for simplicity, such as controllers, buffers (caches), drivers, repeaters, and receivers, to enable communications. Further, the input/output controller 235 may include address, control, and/or data connections to enable appropriate communications among the aforementioned components. The processing system 201 can further include a display controller 225 coupled to the multi-touch display 126. The display controller 225 may drive output to be rendered on the multi-touch display 126.

The processing circuitry 205 is hardware for executing software, particularly software stored in memory 210. The processing circuitry 205 can include any custom made or commercially available processor, a central processing unit (CPU), an auxiliary processor among several processors associated with the processing system 201, a semiconductor based microprocessor (in the form of a microchip or chip set), a macroprocessor, or generally any device for executing software instructions.

The memory 210 can include any one or combination of volatile memory elements (e.g., random access memory (RAM, such as DRAM, SRAM, SDRAM, etc.)) and nonvolatile memory elements (e.g., ROM, erasable programmable read only memory (EPROM), electronically erasable programmable read only memory (EEPROM), flash memory, memory card, programmable read only memory (PROM), tape, compact disc read only memory (CD-ROM), digital versatile disc (DVD), disk, diskette, cartridge, cassette or the like, etc.). Moreover, the memory 210 may incorporate electronic, magnetic, optical, and/or other types of storage media. The memory 210 can have a distributed architecture, where various components are situated remote from one another but can be accessed by the processing circuitry 205.

Software in memory 210 may include one or more separate programs, each of which includes an ordered listing of executable instructions for implementing logical functions. In the example of FIG. 2, the software in memory 210 includes a navigation pane control 202, a suitable operating system (OS) 211, and various applications 212. The OS 211 essentially controls the execution of computer programs, such as various modules as described herein, and provides scheduling, input-output control, file and data management, memory management, communication control and related services. Various user interfaces can be provided by the OS 211, the navigation pane control 202, the applications 212, or a combination thereof The navigation pane control 202 can control display and input processing for one or more navigation panes as further described herein.

The navigation pane control 202 may be implemented in the form of a source program, executable program (object code), script, or any other entity comprising a set of instructions to be performed. When a source program, then the program may be translated via a compiler, assembler, interpreter, or the like, which may or may not be included within the memory 210, so as to operate properly in conjunction with the OS 211 and/or the applications 212. Furthermore, the navigation pane control 202 can be written in an object oriented programming language, which has classes of data and methods, or a procedure programming language, which has routines, subroutines, and/or functions.

In exemplary embodiments, the input/output controller 235 receives touch-based inputs from the multi-touch display 126 as detected touches, gestures, and/or movements. The multi-touch display 126 can detect input from one finger 236, multiple fingers 237, a stylus 238, and/or another physical object 239. Multiple inputs can be received contemporaneously or sequentially from one or more users. The multi-touch display 126 may also support physical object recognition using, for instance, one or more scannable code labels 242 on each physical object 239. In one example, the multi-touch display 126 includes infrared (IR) sensing capabilities to detect touches, shapes, and/or scannable code labels. Physical object 239 may be, for instance, a user identification card having an associated IR-detectable pattern for the user as one or more scannable code labels 242 to support login operations or user account and permissions configuration.

Other output devices such as the I/O devices 240, 245 may include input or output devices, for example but not limited to a printer, a scanner, a microphone, speakers, a secondary display, and the like. The I/O devices 240, 245 may further include devices that communicate both inputs and outputs, for instance but not limited to, components of a wireless interface such as a network interface card (NIC) or modulator/demodulator (for accessing other files, devices, systems, or a network), a radio frequency (RF) or other transceiver, a telephonic interface, a bridge, a router, a mobile device, a portable memory storage device, and the like.

In exemplary embodiments, the system 200 can further include a network interface 260 for coupling to a network 214. The network 214 can be an IP-based network for communication between the processing system 201 and any external server, client and the like via a broadband connection. The network 214 transmits and receives data between the processing system 201 and external systems. In exemplary embodiments, network 214 can be a managed IP network administered by a service provider. The network 214 may be implemented in a wireless fashion, e.g., using wireless protocols and technologies, such as WiFi, WiMax, etc. The network 214 can also be a packet-switched network such as a local area network, wide area network, metropolitan area network, Internet network, or other similar type of network environment. The network 214 may be a fixed wireless network, a wireless local area network (LAN), a wireless wide area network (WAN), a personal area network (PAN), a virtual private network (VPN), intranet or other suitable network system and includes equipment for receiving and transmitting signals.

If the processing system 201 is a PC, workstation, intelligent device or the like, software in the memory 210 may further include a basic input output system (BIOS) (omitted for simplicity). The BIOS is a set of essential software routines that initialize and test hardware at startup, start the OS 211, and support the transfer of data among the hardware devices. The BIOS is stored in ROM so that the BIOS can be executed when the processing system 201 is activated.

When the processing system 201 is in operation, the processing circuitry 205 is configured to execute software stored within the memory 210, to communicate data to and from the memory 210, and to generally control operations of the processing system 201 pursuant to the software. The navigation pane control 202, the OS 211, and the applications 212 in whole or in part, but typically the latter, are read by the processing circuitry 205, perhaps buffered within the processing circuitry 205, and then executed.

When the systems and methods described herein are implemented in software, as is shown in FIG. 2, the methods can be stored on any computer readable medium, such as storage 218, for use by or in connection with any computer related system or method.

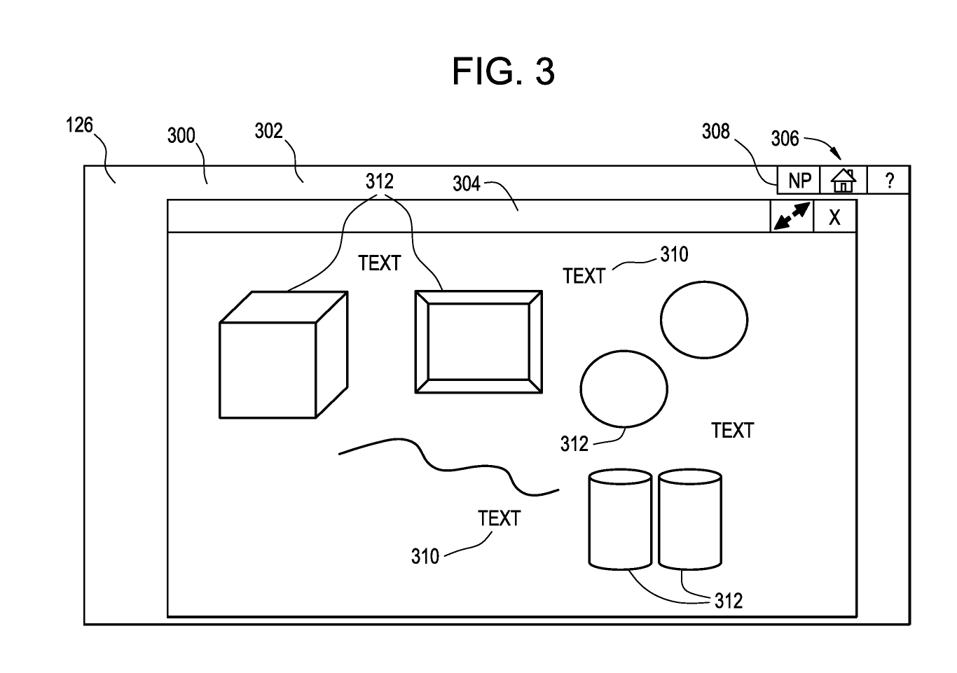

FIG. 3 depicts an example of a user interface 300 of a touch-based environment 302, which is interactively displayed on the multi-touch display 126 of FIG. 1. In the example of FIG. 3, the user interface 300 is equivalent to the touch-based environment 302. An example of a user interface window 304 is displayed as part of the user interface 300. The user interface window 304 may display a variety of text 310 and graphics 312 on the multi-touch display 126. The touch-based environment 302 and the user interface window 304 may be generated by the processing circuitry 205 of FIG. 2 executing one or more of the OS 211 of FIG. 2 and the applications 212 of FIG. 2. The user interface 300 is configured to receive touch-based inputs and respond thereto. When a user desires to launch a navigation pane for reduced-scale navigation of the user interface 300, the user can apply a particular gesture on the multi-touch display 126, such as a letter “N” motion, for example. Alternatively, launching of a navigation pane can be based on placement of a physical object 239 of FIG. 2 including one or more scannable code labels 242 on the multi-touch display 126 as previously described in reference to FIG. 2. As a further alternative, the user can touch an icon 308 to launch a navigation pane. In the example of FIG. 3, the icon 308 is one of a palette of icons 306 to trigger particular actions.

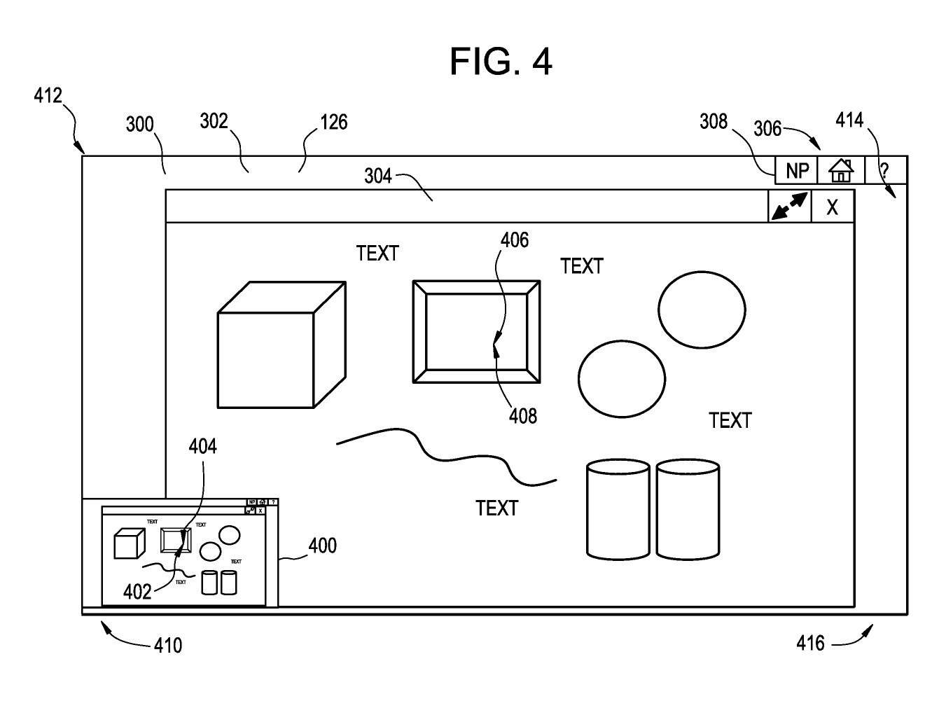

An example of a navigation pane 400 rendered on the multi-touch display 126 is depicted in FIG. 4. The navigation pane 400 may be generated by the processing circuitry 205 of FIG. 2 executing the navigation pane control 202 of FIG. 2. As can be seen in FIG. 4, the navigation pane 400 displays a reduced-scale copy of the user interface 300. Just as the user interface 300 is touch-sensitive, the navigation pane 400 is also touch-sensitive. Touch-based commands that are applied to the navigation pane 400 are interpreted as if they are applied to directly to the user interface 300. A touch-based input 402 applied at a position 404 on the navigation pane 400 is translated into a scaled position 406 on the user interface 300. The touch-based input 402 on the navigation pane 400 is interpreted as an equivalent touch-based input 408 at the scaled position 406 on the user interface 300. For example, if a tap-hold gesture is applied at position 404 on the navigation pane 400, it is interpreted as applying the tap-hold gesture at the scaled position 406 on the user interface 300 and results in triggering an event corresponding to directly applying the tap-hold gesture at the scaled position 406 on the user interface 300. Accordingly, the navigation pane 400 acts as a type of finger pad on a copied or mirrored image of the user interface 300.

The navigation pane 400 is sized as a scaled version of the user interface 300. For example, the navigation pane 400 may have a 1/10 scaling relative to the user interface 300. The relative scaling relationship enables scaling of positions on the navigation pane 400 to scaled positions on the user interface 300. Similarly, movements across the navigation pane 400 are scaled and applied as if they are directly made on the user interface 300. When the navigation pane 400 is actively display, users may provide inputs either through the navigation pane 400 or directly on the user interface 300. Alternatively, the tabletop computer system 100 of FIGS. 1 and 2 may be configured to only accept inputs from the navigation pane 400 while the navigation pane 400 is active, thereby blocking any potentially conflicting inputs between the navigation pane 400 and direct input on the user interface 300.

In the example of FIG. 4, upon launching the navigation pane 400, it is positioned at a lower-left corner 410 overlaying the user interface 300. The navigation pane 400 may be statically positioned on the multi-touch display 126, or the navigation pane 400 can be dynamically positioned on the multi-touch display 126. In one example, by tapping the icon 308, the navigation pane 400 can be relocated between the lower-left corner 410, upper-left corner 412, upper-right corner 414, and lower-right corner 416. When toggling between the corners 410-416, the actual position of the navigation pane 400 may be slightly offset to avoid blocking selected elements, e.g., preventing overlay of the palette of icons 306. Various methods of closing the navigation pane 400 can also be employed, such as tapping and holding the icon 308 for an extended period of time.

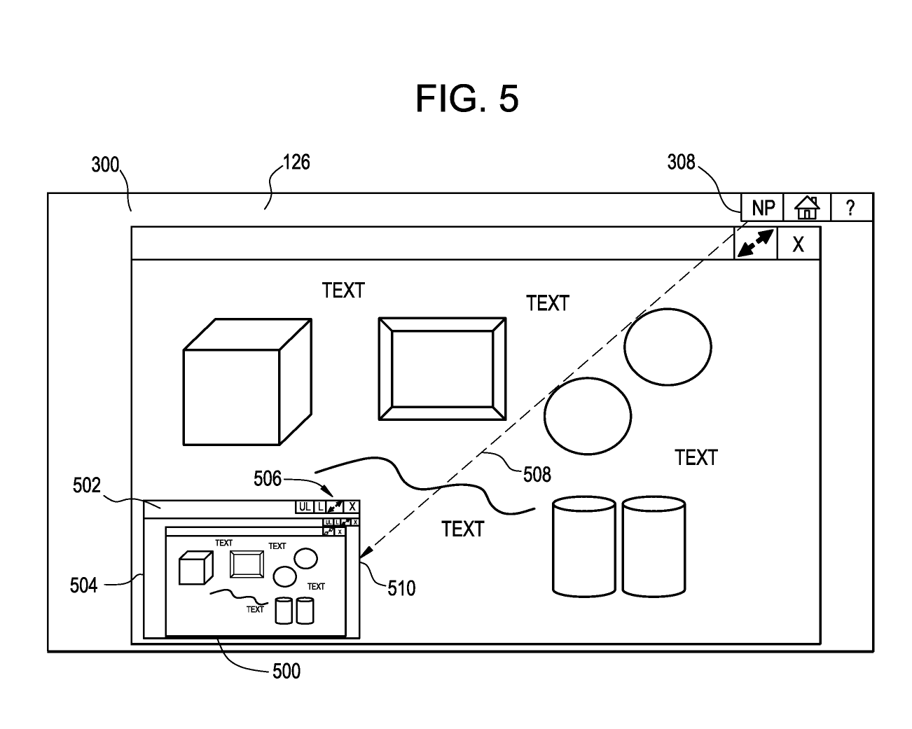

FIG. 5 depicts an example of a navigation pane 500 including a control bar 502 for the user interface 300. The navigation pane 500 is similar to the navigation pane 400 of FIG. 4 except that it is rendered within a frame 504 that includes the control bar 502 with one or more command icons 506. The one or more command icons 506 trigger touch-based commands for the frame 504 and navigation pane 500. For example, one command can include an unlock command to allow the frame 504 including the navigation pane 500 to be freely moved about on the multi-touch display 126 over the user interface 300. Another command can be a lock command to freeze the frame 504 and navigation pane 500 at the current position, thereby preventing unintentional movement after a desired position is reached. A rescale command may be included to resize the frame 504 and navigation pane 500 with corresponding rescaling to determine positions relative to the user interface 300. A further command can close the frame 504 and navigation pane 500.

A user may select an initial position for the frame 504 and navigation pane 500 based on where a gesture to launch the navigation pane 500 is made or physical object 239 of FIG. 2 is placed on the multi-touch display 126. As another alternative, a user may touch the icon 308 and apply a dragging motion 508 between the icon 308 and a position 510, resulting in displaying the frame 504 and navigation pane 500 at the position 510 on the multi-touch display 126.

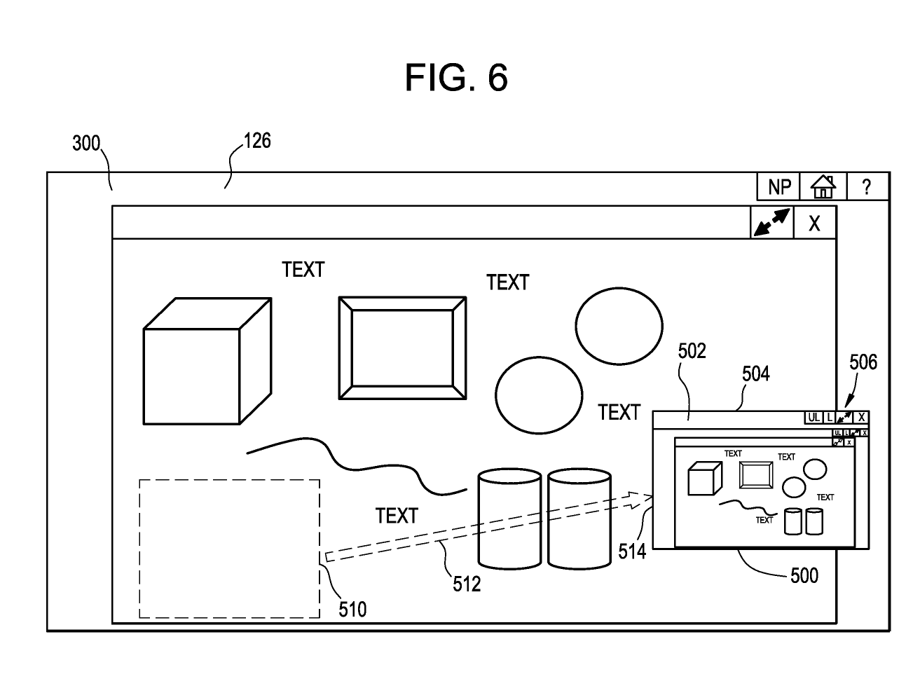

FIG. 6 depicts an example of moving the frame 504 and navigation pane 500 of FIG. 5 on the multi-touch display 126. While the frame 504 and navigation pane 500 are unlocked, they can be dynamically repositioned by a user. For example, touching the control bar 502 and applying a dragging motion 512 can result in repositioning the frame 504 and navigation pane 500 from position 510 to a new position 514. Although the examples of FIGS. 5 and 6 include one or more command icons 506 on the control bar 502, it will be understood that features such as locking/unlocking as well as the one or more command icons 506 can be omitted in embodiments while still enabling dynamic repositioning of the frame 504 and navigation pane 500.

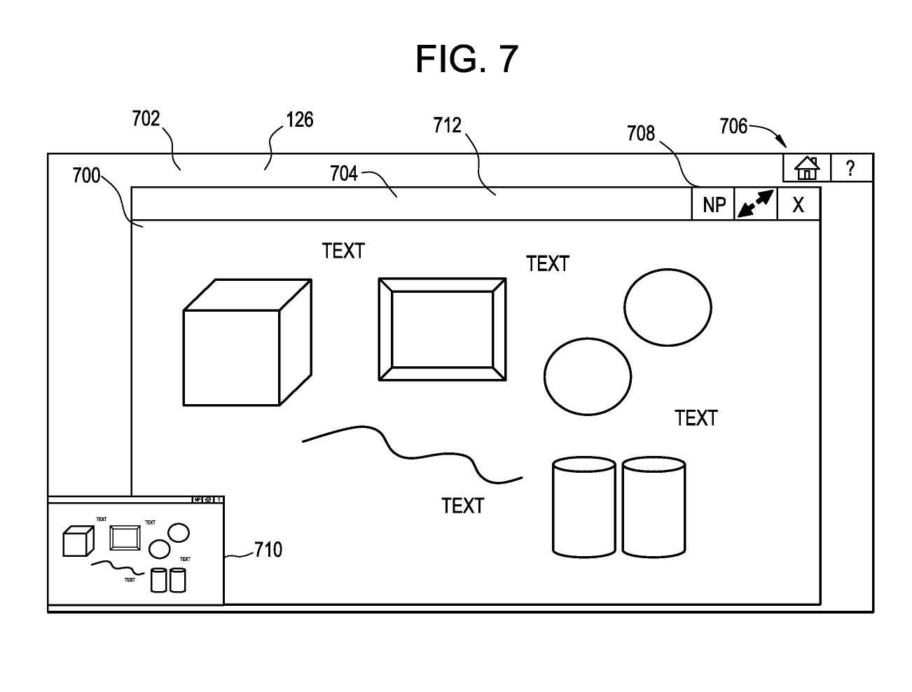

FIG. 7 depicts another embodiment of a navigation pane 710, which is interactively displayed on the multi-touch display 126. In the example of FIG. 7, user interface 700 refers to an actively selected user interface, which is user interface window 704 rather than a complete touch-based environment 702. Here, the touch-based environment 702 refers to a combination of the user interface window 704 and a palette of icons 706 that are external to the user interface window 704. A navigation pane icon 708 is defined on a control bar 712 of the user interface window 704 in the example of FIG. 7. The user interface 700 is interactively displayed in the navigation pane 710 as a reduced-scale copy of the user interface window 704 in FIG. 7. Displaying less than the complete touch-based environment 702 in the navigation pane 710 may allow for greater zooming and detail to be displayed in a relatively small area on the multi-touch display 126. Similar to previously described examples, the navigation pane 710 can be launched by making a particular gesture, placement of physical object 239 of FIG. 2, or touching the navigation pane icon 708.

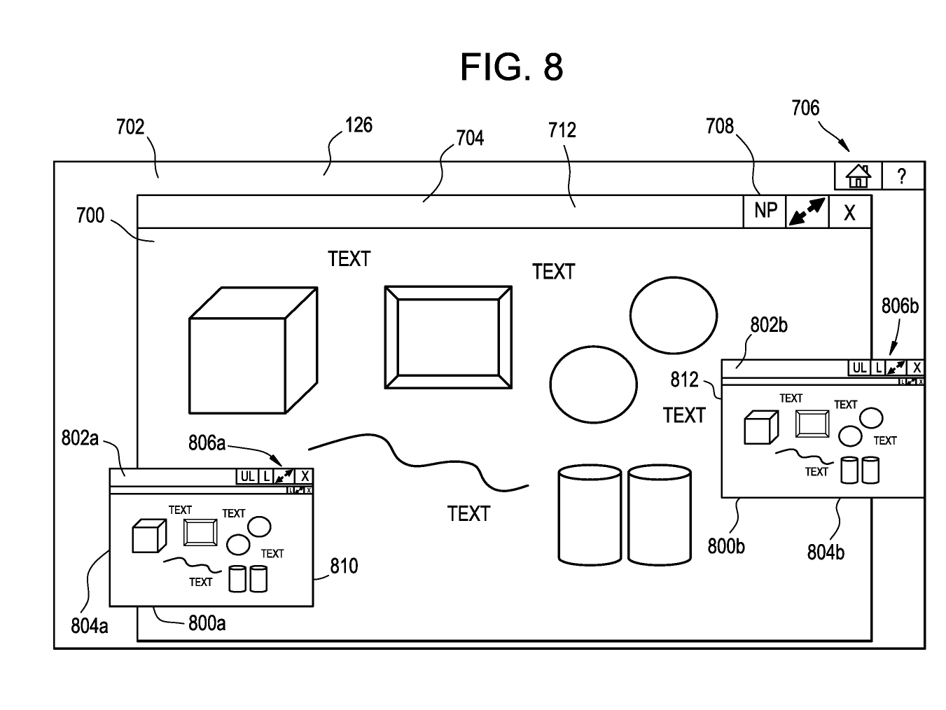

FIG. 8 depicts an example of multiple navigation panes 800a and 800b with control bars 802a and 802b, which are interactively displayed on the multi-touch display 126. FIG. 8 also depicts the user interface 700, the touch-based environment 702, the user interface window 704, the group of icons 706, and the navigation pane icon 708 on the control bar 712 of the user interface window 704 of FIG. 7. Each of the navigation panes 800a and 800b is similar to the navigation pane 710 of FIG. 7 by displaying the user interface 700; however, similar to FIGS. 5 and 6, FIG. 8 includes frames 804a and 804b that respectively include the control bars 802a and 802b with one or more command icons 806a and 806b. The frame 804a and navigation pane 800a are located at a position 810, while the frame 804b and navigation pane 800b are located at a second position 812. The navigation pane 800b is an example of an additional navigation pane rendered on the multi-touch display 126.

Multiple navigation panes may be useful where the diagonal measurement D (FIG. 1) of the multi-touch display 126 is relatively large, e.g., greater than 60 inches (152.4 cm), and multiple users are simultaneously interacting with the multi-touch display 126. While the example of FIG. 8 only includes the user interface window 704 in each of the navigation panes 800a and 800b, the use of multiple navigation panes can also be applied where the user interface 700 is equivalent to the complete touch-based environment 702. As a further alternative, the navigation panes 800a and 800b can have different user interfaces, where one provides a reduced-scale copy of the user interface window 704 and another provides a reduced-scale copy of the touch-based environment 702.

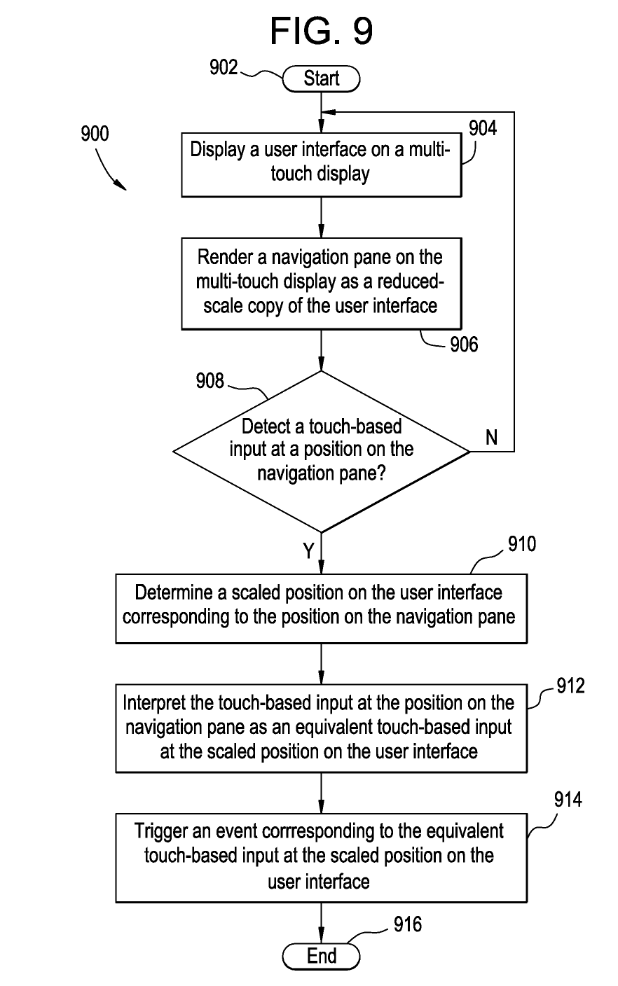

FIG. 9 depicts a process 900 for providing navigation control for the tabletop computer system 100 of FIG. 1 in accordance with exemplary embodiments. The process 900 is described in reference to FIGS. 1-9. The process 900 begins at block 902 and transitions to block 904. At block 904, the processing circuitry 205 of FIG. 2 displays a user interface, such as the user interface 300, on the multi-touch display 126. The user interface 300 can refer to the touch-based environment 302 or the user interface window 304 of the touch-based environment 302.

At block 906, the processing circuitry 205 renders a navigation pane, such as the navigation pane 400, on the multi-touch display 126, where the navigation pane 400 is a reduced-scale copy of the user interface 300. The navigation pane may be statically positioned on the multi-touch display 126. Alternatively, the processing circuitry 205 can be configured to dynamically position the navigation pane on the multi-touch display 126, such as the dynamic positioning of the navigation pane 500 of FIG. 6.

At block 908, the processing circuitry 205 determines whether a touch-based input is detected at a position on the navigation pane, such as touch-based input 402 at position 404 on the navigation pane 400 of FIG. 4. If a touch-based input is detected, the process 900 continues to block 910; otherwise, the process 900 may return to block 904.

At block 910, the processing circuitry 205 determines a scaled position on the user interface corresponding to the position on the navigation pane. As described in the example of FIG. 4, the scaled position 406 can be determined by applying a relative scaling difference between the navigation pane 400 and the user interface 300 to the position 404 on the navigation pane 400. For instance, if the navigation pane 400 is one-tenth scale of the user interface 300, coordinates representing the position 404 can be scaled by a factor of ten to determine the scaled position 406.

At block 912, the processing circuitry 205 interprets the touch-based input at the position on the navigation pane as an equivalent touch-based input at the scaled position on the user interface. Continuing with the example of FIG. 4, the touch-based input 402 at position 404 on the navigation pane 400 can be interpreted as equivalent touch-based input 408 at the scaled position 406 on the user interface 300.

At block 914, the processing circuitry 205 triggers an event corresponding to the equivalent touch-based input at the scaled position on the user interface. The triggered event is the same event that would be triggered by directly touching the user interface at the scaled position. For example, if applying a particular gesture directly at the scaled position 406 on the user interface 300 results in opening a particular context menu (not depicted), then applying the same gesture at the position 404 of the navigation pane 400 corresponding to the scaled position 406 results in opening the same context menu (not depicted) for interactive use at both the position 404 and the scaled position 406.

As previously described, the processing circuitry 205 can be configured to launch a navigation pane based on one or more of: a detected gesture on the multi-touch display 126, a detected touch of an icon on the multi-touch display 126, and a detected placement of a physical object on the multi-touch display 126. The navigation pane may be resizable with corresponding rescaling relative to the user interface as described in the example of FIG. 5. The processing circuitry 205 can also be configured to respond to both direct touch-based inputs on the user interface and the equivalent touch-based input, such as directly touching the user interface 300 at the scaled position 406 or touching the navigation pane 400 at position 404 of FIG. 4.

Multiple instances of the process 900 can operate in parallel such that additional navigation panes can be contemporaneously displayed, where the processing circuitry 205 is configured to render one or more additional navigation panes on the multi-touch display 126. An example of this is depicted in FIG. 8 as previously described.

In exemplary embodiments, a technical effect is providing navigation control for a tabletop computer system. Providing a navigation pane as a scaled version of the user interface enables a user to make physically smaller movements relative to a larger sized user interface while providing access to control features of the larger sized user interface. The navigation pane can be generated as an interactive mirrored copy of the larger sized user interface on a same multi-touch display of the tabletop computer system.

As will be appreciated by one skilled in the art, aspects of the present invention may be embodied as a system, method or computer program product. Accordingly, aspects may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects may take the form of a computer program product embodied in one or more computer readable medium(s) having computer readable program code embodied thereon.

Any combination of one or more computer readable medium(s) may be utilized including a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contains, or stores a program for use by or in connection with an instruction execution system, apparatus, or device.

Program code embodied on a computer readable medium as a non-transitory computer program product may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects are described with reference to flowchart illustrations and/or block diagrams of methods, apparatus (systems) and computer program products according to embodiments. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments. In this regard, each block in the flowchart or block diagrams may represent a module, segment, or portion of code, which includes one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

In exemplary embodiments, where the navigation pane control 202 of FIG. 2 is implemented in hardware, the methods described herein can implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

While the invention has been described in detail in connection with only a limited number of embodiments, it should be readily understood that the invention is not limited to such disclosed embodiments. Rather, modifications can incorporate any number of variations, alterations, substitutions or equivalent arrangements not heretofore described, but which are commensurate with the spirit and scope of the invention. Additionally, while various embodiments have been described, it is to be understood that aspects may include only some of the described embodiments. Accordingly, the invention is not to be seen as limited by the foregoing description, but is only limited by the scope of the appended claims.

1. A system for providing navigation control for a tabletop computer system, the system comprising:
a multi-touch display; and
processing circuitry coupled to the multi-touch display, the processing circuitry configured to:
display a user interface on the multi-touch display;
render a navigation pane on the multi-touch display, the navigation pane comprising a reduced-scale copy of the user interface;
detect a touch-based input at a position on the navigation pane;
determine a scaled position on the user interface corresponding to the position on the navigation pane;
interpret the touch-based input at the position on the navigation pane as an equivalent touch-based input at the scaled position on the user interface; and
trigger an event corresponding to the equivalent touch-based input at the scaled position on the user interface.

2. The system according to claim 1, wherein the navigation pane is statically positioned on the multi-touch display.

3. The system according to claim 1, wherein the processing circuitry is further configured to dynamically position the navigation pane on the multi-touch display.

4. The system according to claim 1, wherein the processing circuitry is further configured to render one or more additional navigation panes on the multi-touch display.

5. The system according to claim 1, wherein the navigation pane is resizable with corresponding rescaling relative to the user interface.

6. The system according to claim 1, wherein the user interface is a user interface window of a touch-based environment.

7. The system according to claim 1, wherein the processing circuitry is further configured to launch the navigation pane based on one or more of: a detected gesture on the multi-touch display, a detected touch of an icon on the multi-touch display, and a detected placement of a physical object on the multi-touch display.

8. The system according to claim 1, wherein the processing circuitry is further configured to respond to both direct touch-based inputs on the user interface and the equivalent touch-based input.

9. A method for providing navigation control for a tabletop computer system, the method comprising:
displaying a user interface on a multi-touch display;
rendering, by processing circuitry coupled to the multi-touch display, a navigation pane on the multi-touch display, the navigation pane comprising a reduced-scale copy of the user interface;
detecting, by the processing circuitry, a touch-based input at a position on the navigation pane;
determining, by the processing circuitry, a scaled position on the user interface corresponding to the position on the navigation pane;
interpreting, by the processing circuitry, the touch-based input at the position on the navigation pane as an equivalent touch-based input at the scaled position on the user interface; and
triggering, by the processing circuitry, an event corresponding to the equivalent touch-based input at the scaled position on the user interface.

10. The method according to claim 9, further comprising:
statically positioning the navigation pane on the multi-touch display.

11. The method according to claim 9, further comprising:
dynamically positioning the navigation pane on the multi-touch display.

12. The method according to claim 9, further comprising:
rendering one or more additional navigation panes on the multi-touch display.

13. The method according to claim 9, wherein the user interface is a user interface window of a touch-based environment.

14. The method according to claim 9, further comprising:
launching the navigation pane based on one or more of: a detected gesture on the multi-touch display, a detected touch of an icon on the multi-touch display, and a detected placement of a physical object on the multi-touch display.

15. The method according to claim 9, further comprising:
responding to both direct touch-based inputs on the user interface and the equivalent touch-based input.

16. A computer program product for providing navigation control for a tabletop computer system, the computer program product including a non-transitory computer readable medium storing instructions for causing processing circuitry coupled to a multi-touch display to implement a method, the method comprising:
displaying a user interface on the multi-touch display;
rendering a navigation pane on the multi-touch display, the navigation pane comprising a reduced-scale copy of the user interface;
detecting a touch-based input at a position on the navigation pane;
determining a scaled position on the user interface corresponding to the position on the navigation pane;
interpreting the touch-based input at the position on the navigation pane as an equivalent touch-based input at the scaled position on the user interface; and
triggering an event corresponding to the equivalent touch-based input at the scaled position on the user interface.

17. The computer program product according to claim 16, further comprising:
performing one or more of: statically positioning the navigation pane on the multi-touch display; and dynamically positioning the navigation pane on the multi-touch display.

18. The computer program product according to claim 16, further comprising:
rendering one or more additional navigation panes on the multi-touch display.

19. The computer program product according to claim 16, further comprising:
launching the navigation pane based on one or more of: a detected gesture on the multi-touch display, a detected touch of an icon on the multi-touch display, and a detected placement of a physical object on the multi-touch display.

20. The computer program product according to claim 16, further comprising:
responding to both direct touch-based inputs on the user interface and the equivalent touch-based input.
